(19) United States
(12) Patent Application Publication
(10) Pub. No.: US 2019/0295136 A1
(43) Pub. Date: Sep. 26, 2019

(54) METHOD AND DEVICE FOR RELEASING EVALUATION INFORMATION

(71) Applicant: KOUBEI HOLDING LIMITED, George Town, Grand Cayman (KY)

(72) Inventors: Chi Fan, Hangzhou City (CN); Chaofeng Meng, Hangzhou City (CN); Han Luo, Hangzhou City (CN); Yihuan Sui, Hangzhou City (CN); Fangyu Dou, Hangzhou City (CN)

(73) Assignee: KOUBEI HOLDING LIMITED, George Town, Grand Cayman (KY)

(21) Appl. No.: 16/463,872

(22) PCT Filed: Nov. 21, 2017
(86) PCT No.: PCT/CN2017/112064

§ 371 Date: May 24, 2019

(30) Foreign Application Priority Data
Nov. 25, 2016 (CN) 201611060615.9

(51) Int. Cl. G06Q 30/02; G06Q 50/12

(52) U.S. Cl. CPC G06Q 30/0282; G06Q 50/12

(57) ABSTRACT

A method and apparatus for releasing evaluation information, in which the feature value corresponding to the object to be evaluated is determined according to the operation information actually occurred by the object to be evaluated, and the comparison value corresponding to the category is determined according to feature values of part or all objects whose category is the same as that of the object to be evaluated. Since the feature value and the comparison value are determined according to the operation information occurred actually without relying on the subjective evaluation of human in the present application, it is more accurate when comparing with the prior art.

### FIELD OF THE INVENTION

The present application relates to the field of information technology, and in particular, to a method and apparatus for releasing evaluation information.

### BACKGROUND OF THE INVENTION

With the popularity and development of the Internet, people have become more and more accustomed to searching for information they need, such as music, video, e-book, restaurant, etc., on the Internet. Nowadays, with massive information flooding the Internet, how to make users quickly and easily find the information they need in a complicated network environment has become an urgent problem to be solved.

The release of evaluation information is one of the effective means to solve the above problem. Generally, for a certain object (such as the above music, video, e-book, restaurant, etc.) to be evaluated, the evaluation of a user who has used the object to be evaluated can be collected, and the collected evaluation is released as the evaluation information corresponding to the object to be evaluated, so that other users can use the evaluation information as a reference basis for judging whether the object to be evaluated meets with their own demands. These evaluation information can be either textual or numerical.

For example, for information about a restaurant on the network, after the user A eats at the restaurant, the numerical rating “4.5” of the user A to the restaurant can be sent to the corresponding server, and the server uses these evaluations as the evaluation information of the restaurant and releases the evaluation information.

However, the above method in the prior art mainly relies on the subjective evaluation of the user, cannot accurately reflect the objective real situation of the object to be evaluated, and the reference value is not high, which makes it inconvenient for other users to search for the information they need according to the evaluation information.

### BRIEF SUMMARY OF THE INVENTION

The embodiment of the present invention provides a method and apparatus for releasing evaluation information, which are used to solve the problem that the method for releasing evaluation information may cause inconvenience to users when searching for the information they needs in the prior art.

The present application adopts the following technical solutions: A method for releasing evaluation information, comprising: receiving each operation information carrying an identity of an object to be evaluated; determining a feature value corresponding to the object to be evaluated according to said each the operation information, and determining a category to which the object to be evaluated belongs according to the identity of the object to be evaluated; determining a comparison value corresponding to the category, and comparing the feature value corresponding to the object to be evaluated with the comparison value; wherein the comparison value is determined according to feature values corresponding to part or all objects in the category; and, determining, according to the comparison result, and releasing the evaluation information of the object to be evaluated.

A method for releasing evaluation information, comprising: receiving each payment information carrying an identity of a restaurant; determining a feature value corresponding to the restaurant according to said each payment information, and determining a category to which the restaurant belongs according to the identity of the restaurant; determining a comparison value corresponding to the category, and comparing the feature value corresponding to the restaurant with the comparison value; wherein the comparison value is determined according to feature values corresponding to part or all restaurants in the category; and, determining, according to the comparison result, and releasing the evaluation information of the restaurant.

An apparatus for releasing evaluation information, comprising: a receiving module for receiving each operation information carrying an identity of an object to be evaluated; a determining module for determining a feature value corresponding to the object to be evaluated according to said each operation information, and determining a category to which the object to be evaluated belongs according to the identity of the object to be evaluated; a comparing module for determining a comparison value corresponding to the category, and comparing the feature value corresponding to the object to be evaluated with the comparison value; wherein the comparison value is determined according to feature values corresponding to part or all objects in the category; and, a releasing module for determining, according to the comparison result, and releasing the evaluation information of the object to be evaluated.

An apparatus for releasing evaluation information, comprising: a receiving module for receiving each payment information carrying an identity of a restaurant; a determining module for determining a feature value corresponding to the restaurant according to said each payment information, and determining a category to which the restaurant belongs according to the identity of the restaurant; a comparing module for determining a comparison value corresponding to the category, and comparing the feature value corresponding to the restaurant with the comparison value; wherein the comparison value is determined according to feature values corresponding to part or all restaurants in the category; and, a releasing module for determining, according to the comparison result, and releasing the evaluation information of the restaurant.

The present application determines the feature value corresponding to the object to be evaluated according to the operation information actually occurred by the object to be evaluated, and determines the comparison value corresponding to the category according to the feature values of part or all objects whose category is the same as that of the object to be evaluated. Since the feature value and the comparison value are determined according to the operation information occurred actually without relying on the subjective evaluation of human in the present application, it is more accurate when comparing with the prior art. Moreover, the evaluation information of the object to be evaluated is determined according to the comparison result of the feature value and the comparison value, which can accurately reflect the level of the object to be evaluated when comparing with other objects of the same category, and further improves the accuracy for releasing the evaluation information. When users search for the information they need based on the evaluation information released by the present application, it can effectively improve the convenience for their search.

### BRIEF DESCRIPTION OF THE SEVERAL VIEWS OF THE DRAWING

The accompany drawings described herein are intended to provide a further understanding of the present application, and constituted to be a part of the present application. The illustrative embodiments of the present application and the description thereof are for explaining the present application and do not constitute an improper limitation to the present application. In the accompany drawings:

FIG. 1 is a procedure for releasing evaluation information provided by an embodiment of the present application;

FIG. 2 is a procedure for releasing evaluation information of a restaurant provided by an embodiment of the present application;

FIG. 3 is a schematic structural diagram of an apparatus for releasing evaluation information provided by an embodiment of the present application;

FIG. 4 is a schematic structural diagram of another apparatus for releasing evaluation information provided by an embodiment of the present application.

### DETAILED DESCRIPTION OF THE INVENTION

It can be known from the prior art that the prior art mostly relies on the rating of a user to the object to be evaluated that is obtained based on the user's subjective evaluation, which not only reduces the accuracy of the evaluation information of the object to be evaluated, but also lacks the horizontal comparison between objects in the same category. For example, for two objects with 4.5 scores, both of which are obtained by relying on the user's subjective evaluation, in the same category, which comparison result of the two objects in the category is betterC? The conclusion is obviously not given in the prior art. This leads to the fact that the rating of each object to be evaluated in the prior art is almost meaningless, and it is obviously not convenient for the user to search for the information they need according to these ratings.

However, the evaluation information released in the present application do not rely on the subjective evaluation of the user, and a feature value corresponding to the object to be evaluated is obtained by the operation information actually occurred by the object to be evaluated, and the feature value is compared with a comparison value obtained according to feature values corresponding to all or part of objects in the same category, which is equivalent to performing horizontal comparison between the objects in the same category, and finally the evaluation information of the object to be evaluated are obtained according to the comparison result and are released, which makes the released evaluation information more accurately reflect the level of the object to be evaluated among the objects in same category, thereby it can improve the convenience of the user to search for the information he/she needs according to the evaluation information.

In order to make objects, technical solutions and advantages of the present application more clearly, it will clearly and completely describe the technical solutions of the present application with reference to the specific embodiments of the present application and the corresponding accompanying drawings in the following. It is apparent that the described embodiments are only a part of the embodiments of the present application, rather than all of the embodiments. Based on the embodiments in the present application, all other embodiments obtained by an ordinary person skilled in the art without creative efforts are within the scope of the present application.

The technical solution provided by each embodiment of the present application is described in detail below with reference to the accompanying drawings.

### Embodiment 1

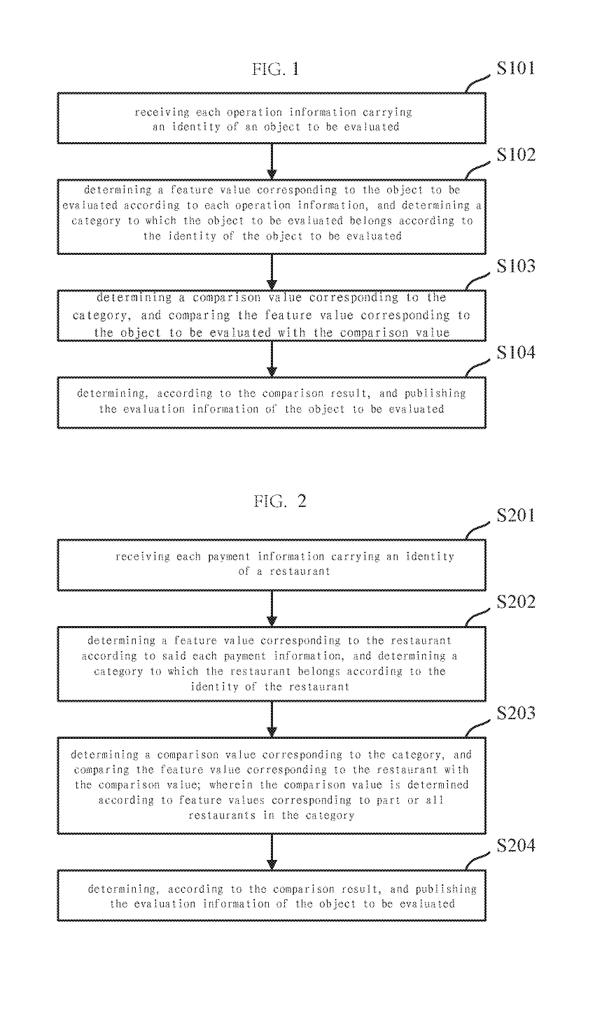

FIG. 1 is a procedure for releasing evaluation information provided by an embodiment of the present application, which specifically includes the following steps:

S101: receiving each operation information carrying an identity of an object to be evaluated.

Since the objects to be evaluated are information, such as music, video, e-book, restaurant, etc., on the network in the embodiment of the present application, all of these information can be operated by users after being searched by the users. Therefore, in the embodiment of the present application, the operation information of the users for operating these objects to be evaluated may be received by a server that provides these objects to be evaluated. Of course, the operation information of the users for operating these objects to be evaluated may also be received by other servers or devices.

For example, it is assumed that the object to be evaluated is a video on the network, when a user views or downloads the video, the server accordingly receives the operation information carrying the identity of the video.

S102: determining a feature value corresponding to the object to be evaluated according to each operation information, and determining a category to which the object to be evaluated belongs according to the identity of the object to be evaluated.

In the embodiment of the present application, the feature value corresponding to the object to be evaluated may be determined according to the preset feature dimension and the received operation information that carries the identity of the object to be evaluated. The feature dimension can be set as needed.

Continuing with the above example, for the video on the network, the feature dimension can be set as the user's number of viewings, viewing time, download times, and the like. Assuming that the feature dimension is number of viewings, the server can count the number of times that the video is viewed as the feature value corresponding to the video according to the operation information after receiving the operation information carrying the identity of the video.

In addition, since the feature value of the object to be evaluated needs to be compared with other objects in the same category, it is also necessary to determine the category to which the object to be evaluated belongs. In the present application, the category to which the object to be evaluated belongs may be determined according to the identity of the object to be evaluated carried in the received operation information.

Specifically, the corresponding relationship between each identity and each category may be preset. After the operation information carrying the identity of the object to be evaluated is received through step S101, the category to which the object to be evaluated belongs may be determined according to the corresponding relationship and the identity carried in the operation information. Continuing with the above example, after receiving the operation information carrying the identity of the video, the server may determine the category to which the video belongs as a funny category according to the identity of the video and the preset corresponding relationship between each identity and each video category.

Of course, when an identity is assigned to each object to be evaluated in advance, one or several certain bits in the identity may be set as a category code, and after receiving the operation information carrying the identity of the object to be evaluated through step S101, the category to which the object to be evaluated belongs may be determined directly according to the category code included in the identity carried in the operation information. Those skilled in the art should understand that as long as the category to which the object to be evaluated belongs be determined according to the identity of the object to be evaluated carried in the operation information, the present application make any limitations on this.

In addition, it should be illustrated that, in the embodiment of the present application, after the server receives each operation information, the execution order of the step of determining the feature value corresponding to the object to be evaluated according to the operation information and the step of determining the category to which the object to be evaluated belongs according to the identity of the object to be evaluated is not limited to a specific precedence relationship, and the feature value may be determined first, or the category to which the object to be evaluated belongs may be determined first, and of course, they may be executed simultaneously.

S103: determining a comparison value corresponding to the category, and comparing the feature value corresponding to the object to be evaluated with the comparison value.

In the embodiment of the present application, the comparison value is determined according to feature values corresponding to part or all objects in the category to which the object to be evaluated belongs. The comparison value may be determined in advance according to historical feature values of part or all of the objects in the category, or may be determined in real time according to the current feature values of part or all objects in the category. Specifically, the comparison value corresponding to the category may be determined according to the feature values corresponding to part or all objects in the category and a preset algorithm, for example, an arithmetic average or geometric average of the feature values corresponding to part or all objects in the category may be determined as the comparison value corresponding to the category. The above preset algorithm is not limited in the present application.

Further, in order to make the evaluation information obtained subsequently more accurate, in the present application, when the comparison value is determined, the attribute of the object to be evaluated may be determined according to the identity of the object to be evaluated, and among other objects other than the object to be evaluated in the category, other objects having the same attribute with the object to be evaluated are determined, and the comparison value corresponding to the category is determined according to the determined feature values corresponding to the other objects, wherein the attribute may also be set according to requirements. For example, when the object to be evaluated is a video, the attribute may be set as the releasing time of the video, the playing duration, and the like.

Continuing with the above example, after determining that the category to which the video belongs is a funny category in step S102, the server may query the playing duration of the video according to the identity of the video. Assuming that the playing duration of the video is 30˜60 minutes, and in all of the videos belonging to the funny category, other videos whose playing duration is also 30˜60 minutes are determined, and then the comparison value corresponding to the funny category is determined according to the determined number of viewings corresponding to the other videos.

S104: determining, according to the comparison result, and releasing the evaluation information of the object to be evaluated.

In the present application, after the comparison value corresponding to the category to which the object to be evaluated belongs is determined through step S103, and the feature value corresponding to the object to be evaluated is compared with the comparison value, the evaluation information of the object to be evaluated may be determined according to the comparison result and is released.

Specifically, the server may determine a score corresponding to the comparison result according to a preset rule, and determine, according to the score, the evaluation information of the object to be evaluated and release the evaluation information. The preset rule may also be set according to requirements, for example, the score corresponding to the comparison result may be determined according to the difference obtained by subtracting the comparison value from the feature value. The larger the difference is, the higher the score is, or, the larger the difference is, the lower the score is.

Continuing with the above example, assuming that the number of viewings (feature value) corresponding to the video is 700, and the average number of viewings (comparison value) of videos of the funny category is 500, then the score corresponding to the comparison result of them may be determined as 7 (out of 10) according to the preset rule. The score can be directly determined as the evaluation information of the video for release subsequently.

Further, considering in the actual application scenario, although the accuracy of the user's subjective evaluation is low, there is still some reference significance. Therefore, in the embodiment of the present application, when determining the evaluation information of the object to be evaluated, the final evaluation information is influenced mainly based on the score corresponding to the above comparison result and supplemented by considering the subjective evaluation of the user. Specifically, the user's rating to the object to be evaluated in history may be determined, and the evaluation information of the object to be evaluated is determined according to the preset weight corresponding to the rating and the score corresponding to the comparison result. The rule for specifically determining the evaluation information according to the above weight and the score is not limited in the present application.

Continuing with the above example, assuming that the rating of the user to the video in history is 4.5 (out of 5), and according to the preset weight of 5% corresponding to the rating of 4.5 and the score of 7 corresponding to the above comparison result, the score of 7 is reduced by 5% to get a final score of 6.65. The score of 6.65 can be determined as the evaluation information of the video for release finally.

It can be seen from the above procedure that the evaluation information obtained in the present application does not rely on the subjective evaluation of the user, and horizontal comparison between the objects in the same category is performed on the object to be evaluated, and the evaluation information obtained thereby can accurately reflect the level of the object to be evaluated in the same category. Compared with the prior art, it can provide the user with more valuable evaluation information, thereby it can improve the convenience for the user to search for the information they need.

Furthermore, in the prior art, since the evaluation information of the object to be evaluated is updated only after the subjective evaluation of the user is collected, the evaluation information in the prior art is relatively lagging and the real-time performance is low. In order to improve the real-time performance of the evaluation information, in the above step S101, the server may receive, according to a preset period, each operation information carrying the identity of the object to be evaluated that is sent within the current period, and thus, in step S102, the server may determine, according to each operation information received within the current period, the feature value of the object to be evaluated, and compare the feature value determined within the current period with the comparison value corresponding to the category to which the object to be evaluated belongs in step S103, and finally, the evaluation information within the current period is obtained. That is, the evaluation information of the object to be evaluated is updated once per period.

Further, when the server periodically updates the evaluation information of the object to be evaluated, in step S103, if the comparison value is determined according to the historical feature value of part or all of the objects in the category to which the object to be evaluated belongs, the server may determine a historical period corresponding to the current period, and determine a comparison value determined based on the historical period as a comparison value corresponding to the category, wherein the comparison value determined based on the historical period is determined according to the feature value corresponding to each object in the category determined within the historical period.

Still illustrating by taking the object to be evaluated being a video as an example, assuming that the preset period is 1 hour and the current period is 19:00˜20:00 on Nov. 23, 2016, the server may determine that 19:00˜20:00 of the previous day is the historical period corresponding to the current period, that is, the historical period is 19:00˜20:00 on Nov. 22, 2016, according to the corresponding relationship between the preset periods. Subsequently, the server may determine an average number of viewings corresponding to videos of the funny category that was previously determined within the historical period (19:00˜20:00 on Nov. 22, 2016) as the comparison value corresponding to the videos of the funny category. In addition, the server may also statistically determine and record the average number of viewings corresponding to the videos of the funny category within the current period (19:00˜20:00 on Nov. 23, 2016), so as to use the average number of viewings determined within the current period as the comparison value subsequently when updating the evaluation information subsequently.

If the comparison value is determined according to the current feature values of part or all of the objects in the category to which the object to be evaluated belongs, the server may determine the feature value corresponding to each object in the category within the current period according to the operation information carrying the identity of each object in the category received within the current period, and may determine the comparison value corresponding to the category according to the feature value corresponding to each object in the category within the current period.

Still illustrating by taking the object to be evaluated being a video as an example, assuming that the preset period is 1 hour and the current period is 19:00˜20:00, the server may determine the number of viewings corresponding to all videos of the funny category within the current period (19:00˜20:00) according to the operation information carrying the identities of all videos of the funny category received in the current period (19:00˜20:00), and hereby determine the average number of viewings corresponding to the videos of the funny category within the current period (19:00˜20:00) as the comparison value corresponding to the videos of the funny category.

### Embodiment 2

The method for releasing evaluation information provided by the present application will be described in detail below by taking the release of evaluation information of the restaurant category information as an example.

FIG. 2 is a procedure for releasing the evaluation information of a restaurant provided by an embodiment of the present application, which specifically includes the following steps:

S201: receiving each payment information carrying an identity of a restaurant.

Considering that in the actual application scenario, the frequency of using online payment in a shopping scene of restaurant, supermarket, or the like is becoming higher and higher. Therefore, in the embodiment of the present application, the evaluation information of the restaurant can be determined and released by the payment information in which a user uses online payment in the restaurant.

Specifically, when the user uses the online payment to checkout in the restaurant, the payment information carrying the identity of the restaurant is sent to the payment server, and the subsequent steps can be directly performed by the payment server subsequently to determine and release the evaluation information of the restaurant, or by obtaining the payment information received by the payment server and determining and releasing the evaluation information of the restaurant by other servers, which will not be repeated here.

In addition, similar to the above-mentioned embodiment 1, the server (the server referred to below may refer to a payment server receiving the payment information, or may also refer to other servers obtaining the payment information from the payment server) may also receive the payment information carrying the identity of the restaurant sent within the current period according to a preset period.

S202: determining a feature value corresponding to the restaurant according to each payment information, and determining a category to which the restaurant belongs according to the identity of the restaurant.

In the embodiment of the present application, the feature value corresponding to the restaurant may be determined according to the preset feature dimension and each of the received payment information, and the feature dimension may be set according to requirements, for example, if the evaluation information to be determined subsequently is the popularity value of the restaurant, the feature value may be the number of collections (this is because, in general, the more the number of collections is, the more users who eat at the restaurant are, and thus the higher the popularity value is), if the evaluation information to be determined subsequently is the average consumption of the restaurant, the feature value may be the payment amount.

In the following, only the evaluation information to be determined subsequently being the popularity value of the restaurant will be taken as an example to illustrate. The server may determine the number of collections of the restaurant within the current period according to each of the received payment information carrying the identity of the restaurant sent within the current period. Specifically, the number of collections of the restaurant within the current period may be counted according to a rule in which one piece of payment information corresponds to one collection.

In addition, the server also needs to determine the category to which the restaurant belongs, such as dinner category, fast food category, or the like, according to the identity of the restaurant carried in the payment information. The detail of the method for determining the category of the restaurant according to the identity of the restaurant is similar to the method for determining the category of the object to be evaluated in the embodiment 1, and it will not be repeated here.

S203: determining a comparison value corresponding to the category, and comparing the feature value corresponding to the restaurant with the comparison value; wherein the comparison value is determined according to feature values corresponding to part or all restaurants in the category.

In the embodiment of the present application, the server may determine a comparison value corresponding to the category according to historical or current feature values of part or all of the restaurants in the category to which the restaurant belongs, and compare the feature value corresponding to the restaurant with the comparison value.

Considering that the popularity of restaurants in different geographical areas may be different, therefore, in order to further improve the accuracy of the evaluation information released subsequently, the server may determine the geographical area where the restaurant locates according to the identity of the restaurant when determining the comparison value corresponding to the category, and determine other restaurants whose geographical area is the same as the geographical area where the restaurant locates among other restaurants other than the restaurant in the category, and then determine the comparison value corresponding to the category according to feature values corresponding to the determined other restaurants.

Specifically, if the comparison value is determined according to the historical feature values of part or all of the restaurants in the category to which the restaurant belongs, the server may determine a historical period corresponding to the current period, and determine an average number of collections determined based on the historical period as the comparison value corresponding to the category, wherein the average number of collections determined based on the historical period is determined according to the number of collections corresponding to each restaurant in the category determined within the historical period.

For example, it is assumed that the category to which the restaurant belongs corresponding to the identity of the restaurant carried in the payment information received in step S101 is a dinner category, the preset period is 1 hour, and the current period is 12:00-13:00 on Nov. 23, 2016, the server can determine 12:00 to 13:00 of the previous day as the historical period corresponding to the current period according to the corresponding relationship between the preset periods, that is, the historical period is 12:00-13:00 on Nov. 22, 2016. Subsequently, the server may determine the average number of collections corresponding to restaurants in the dinner category that was previously determined in the historical period (12:00-13:00 on Nov. 22, 2016) as the comparison value corresponding to restaurants of the dinner category. In addition, the server may also statistically determine and record the average number of collections corresponding to restaurants of the dinner category that is determined within the current period, so as to use the average number of collections determined in the current period subsequently as the comparison value when updating the evaluation information subsequently.

If the comparison value is determined according to current feature values of part or all of the restaurants in the category to which the restaurant belongs, the server may determine the number of collections corresponding to each restaurant in the category within the current period according to the payment information carrying the identity of each restaurant in the category received within the current period, and determine the average number of collections corresponding to the category according to the number of collections corresponding to each restaurant in the category within the current period.

For example, it is assumed that the category of the restaurant corresponding to the identity of the restaurant carried in the payment information received in step S101 belongs to a dinner category, the preset period is 1 hour, and the current period is 12:00˜13:00, then the server may determine the number of collections of all the restaurants of the dinner category within the current period (12:00˜13:00) according to the payment information carrying the identities of all the restaurants received within the current period (12:00˜13:00), and may hereby determine the average number of collections corresponding to the restaurants of the dinner category within the current period (12:00˜13:00) as the comparison value of the restaurants of the dinner category.

S204: determining, according to the comparison result, and releasing the evaluation information of the restaurant.

Similar to the method for determining the evaluation information of the object to be evaluated in the embodiment 1, in the embodiment of the present application, the server may also determine, according to the preset rule, the average number of collections corresponding to the restaurant and the score corresponding to the comparison result of the average number of collections corresponding to the category to which the restaurant belongs, and then may determine, according to the score, the popularity value of the restaurant as the evaluation information of the restaurant, and release the evaluation information. Wherein, the preset rule may be: the larger the difference obtained by subtracting the average number of collections corresponding to the category to which the restaurant belongs from the number of collections corresponding to the restaurant is, the higher the score corresponding to the comparison result is, which indicates that the popularity value of the restaurant is higher.

Further, similar to the embodiment 1, the popularity value of the restaurant may also be determined by considering the user's subjective rating to the restaurant. Specifically, the server may determine the user's rating to the restaurant in history, and determine the popularity value of the restaurant according to the weight corresponding to the preset rating and the score.

Continuing with the above example, assuming that the number of collections (feature value) corresponding to the restaurant within the current period is 7, and the average number of collections (comparison value) of the restaurants of the dinner category is 5, the score corresponding to the comparison result of them is determined to be 7 (out of 10) according to the preset rule. Suppose that the user's rating to the restaurant is 4.5 (out of 5) in history, then according to the preset weight of 5% corresponding to the rating of 4.5 and the score of 7 corresponding to the above comparison result, the score of 7 may be reduced by 5% to get the final score of 6.65. Finally, the score of 6.65 may be determined as the evaluation information of the restaurant for release.

It should be understood by those skilled in the art that the above embodiment 2 is illustrated only by taking the popularity value of the restaurant being the evaluation information as an example. However, the application scenario of the method for releasing the evaluation information provided by the present application is not limited thereto, and other exemplary application scenarios include, but are not limited to, evaluation information for evaluating the average consumption level of a restaurant, evaluation information for evaluating the hot level of music, e-book or other information, and the like. The use of the above-mentioned method for releasing evaluation information provided by the present application in any scenario is within the scope of the present application.

The technical carrier involved in the payment in the embodiments of the present application may include, for example, Near Field Communication (NFC), WIFI, 3G/4G/5G, POS card swiping technology, two-dimensional code scanning technology, barcode scanning technology, Bluetooth, infrared, Short Message Service (SMS), Multimedia Message Service (MMS), etc.

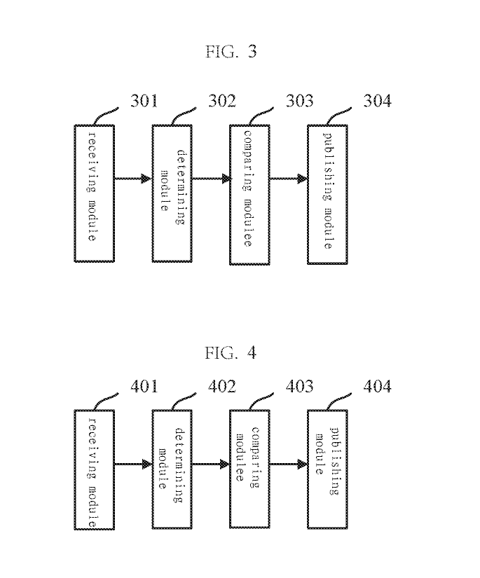

The above is the methods for releasing the evaluation information provided by the embodiments of the present application. Based on the same idea, the present application further provides apparatuses for releasing the corresponding evaluation information, as shown in FIG. 3 and FIG. 4.

FIG. 3 is a schematic structural diagram of an apparatus for releasing evaluation information provided by an embodiment of the present disclosure, which specifically includes:

a receiving module 301 for receiving each operation information carrying an identity of an object to be evaluated;

a determining module 302 for determining a feature value corresponding to the object to be evaluated according to said each operation information, and determining a category to which the object to be evaluated belongs according to the identity of the object to be evaluated;

a comparing module 303 for determining a comparison value corresponding to the category, and comparing the feature value corresponding to the object to be evaluated with the comparison value; wherein the comparison value is determined according to feature values corresponding to part or all objects in the category;

a releasing module 304 for determining, according to the comparison result, and releasing the evaluation information of the object to be evaluated.

The receiving module 301 receives each operation information carrying the identity of the object to be evaluated sent within the current period according to a preset period.

The determining module 302 determines an attribute of the object to be evaluated according to the identity of the object to be evaluated, determines other objects having the same attribute with the object to be evaluated among other objects other than the object to be evaluated in the category, and determines the comparison value corresponding to the category according to feature values corresponding to the determined other objects.

The determining module 302 determines a historical period corresponding to the current period, and determines the comparison value determined based on the historical period as a comparison value corresponding to the category, wherein the comparison value determined based on the historical period is determined according to the feature value corresponding to each object in the category determined within the historical period.

The determining module 302 determines the feature value corresponding to each object in the category within the current period according to the operation information carrying the identity of each object in the category received within the current period, and determines the comparison value corresponding to the category according to the feature value corresponding to each object in the category within the current period.

The releasing module 304 determines a score corresponding to the comparison result according to a preset rule, determines the evaluation information of the object to be evaluated according to the score, and releases the evaluation information.

The releasing module 304 determines a rating of a user to the object to be evaluated in history, and determines the evaluation information of the object to be evaluated according to the preset weight corresponding to the rating and the score.

FIG. 4 is a schematic structural diagram of another apparatus for releasing evaluation information provided by an embodiment of the present application, which specifically includes:

a receiving module 401 for receiving each payment information carrying the identity of a restaurant;

a determining module 402 for determining a feature value corresponding to the restaurant according to said each payment information, and determining a category to which the restaurant belongs according to the identity of the restaurant;

a comparing module 403 for determining a comparison value corresponding to the category, and comparing the feature value corresponding to the restaurant with the comparison value; wherein the comparison value is determined according to feature values corresponding to part or all restaurants in the category;

a releasing module 404 for determining, according to the comparison result, and releasing evaluation information of the restaurant.

The receiving module 401 receives each payment information carrying the identity of the restaurant sent within the current period according to a preset period.

The determining module 402 determines the number of collections of the restaurant in the current period according to each of the received payment information carrying the identity of the restaurant sent within the current period.

The determining module 402 determines a geographical area where the restaurant locates according to the identity of the restaurant, determines other restaurants whose geographical area is the same as the geographic area where the restaurant locates among other restaurants other than the restaurant in the category, and determines the feature value corresponding to the category according to feature values corresponding to the determined other restaurants.

The determining module 402 determines a historical period corresponding to the current period, and determines the average number of collections determined based on the historical period as the comparison value corresponding to the category, where the average number of collections determined based on the historical period is determined based on the number of collections corresponding to each restaurant in the category determined within the historical period.

The determining module 402 determines, according to the payment information carrying the identity of each restaurant in the category received within the current period, the number of collections corresponding to each restaurant in the category within the current period, and determines the average number of collections corresponding to the category according to the number of collections corresponding to each restaurant in the category within the current period.

The releasing module 404 determines a score corresponding to the comparison result according to a preset rule, and determines a popularity value of the restaurant according to the score as the evaluation information of the restaurant, and releases the evaluation information.

The releasing module 404 determines a rating of a user to the restaurant in history, and determines the popularity value of the restaurant according to the preset weight corresponding to the rating and the score.

In the 1990s, it can clearly distinguish whether the improvement to a technology is improvement in hardware (for example, the improvement in a circuit structure such as diode, transistor, switch, etc.) or improvement in software (for example, the improvement in a method flow). However, with the development of technology, the improvement to many method flows in nowadays can be regarded as direct improvement in hardware circuit structure. Designers almost always get the corresponding hardware circuit structure by programming the improved method flow into the hardware circuit. Therefore, it cannot be said that the improvement of a method flow cannot be implemented by hardware entity modules. For example, the Programmable Logic Device (PLD) (e.g., Field Programmable Gate Array (FPGA)) is one of such integrated circuit, in which the logic function is determined by programming on the device by the user. Designers program voluntarily to “integrate” a digital system on a single PLD without asking the chip manufacturer to design and fabricate a dedicated integrated circuit chip. Moreover, nowadays, instead of manually fabricating the integrated circuit chip, this programming is mostly implemented by using “logic compiler” software, which is similar to the software compiler used in writing during programming development, but it requires that the original code before compiling has to be written in a specific programming language. This is called Hardware Description Language (HDL). However, there is not only one kind of HDL, but there are many kinds of HDL, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. Currently, VHDL (Very-High-Speed Integrated Circuit Hardware Description Language) and Verilog are the most commonly used.

Those skilled in the art should also appreciate that the hardware circuit for implementing the logic method flow can be easily obtained by simply programming the method flow with a few hardware description languages described above and programming it into the integrated circuit.

The controller can be implemented in any suitable manner, for example, the controller can take the form of, for example, microprocessor or processor and computer readable medium storing computer readable program code (eg, software or firmware) executable by the (micro)processor, logic gate, switch, application specific integrated circuit (ASIC), programmable logic controller, and embedded microcontroller, examples of controllers include, but are not limited to, the following microcontrollers: ARC 625D, Atmel AT91SAM, Microchip PIC18F26K20 and Silicone Labs C8051F320, the memory controller can also be implemented as part of the control logic of the memory. Those skilled in the art also know that the controller can achieve the same function in the form of logic gate, switch, ASIC, programmable logic controller, embedded microcontroller and the like entirely by logically programming the steps of method, in addition to implementing the controller in pure computer readable program codes. Such a controller can therefore be considered as a hardware part, and the means for implementing various functions included therein can also be considered as a structure within a hardware part. Or, even the means for implementing various functions can be considered as both of a software module for implementing a method and the structure within the hardware component.

The system, apparatus, module or unit illustrated in the above embodiments may be specifically implemented by a computer chip or an entity, or by a product having a certain function. A typical implementation device is a computer. Specifically, the computer can be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For the convenience of description, when describing the above apparatus, the apparatus is divided into various units in functions to describe respectively. Of course, the function of each unit may be implemented in the same one or multiple softwares and/or hardwares when implementing the present application. Those skilled in the art should understand that embodiments of the present invention can be provided as a method, system, or computer program product. Accordingly, the present invention may take the form of an entire hardware embodiment, an entire software embodiment, or an embodiment with the combination of software and hardware. Moreover, the invention can take the form of a computer program product embodied on one or more computer-usable storage media (including, but not limited to, magnetic disk memory, CD-ROM, optical memory, etc.) in which computer usable program codes are contained.

The present invention has been described with reference to flowcharts and/or block diagrams of the method, device (system), and computer program product according to embodiments of the invention. It should be understood that each flow and/or block of the flowcharts and/or block diagrams, and the combination of flows and/or blocks of the flowcharts and/or block diagrams may be implemented by computer program instructions. These computer program instructions can be provided to a processor of a general purpose computer, a special-purpose computer, an embedded processor, or other programmable data processing devices to produce a machine, such that means for implementing the functions specified in one or more flows of the flowcharts and/or one or more blocks of the block diagrams are generated by instructions executed by a processor of a computer or other programmable data processing device.

These computer program instructions can also be stored in a computer readable memory that can guide a computer or other programmable data processing device to operate in a particular manner, such that the instructions stored in the computer readable memory generate an article of manufacture comprising the instruction means. The instruction means implements the functions specified in one or more flows of the flowcharts and/or one or more blocks of the block diagrams.

These computer program instructions can also be loaded onto a computer or other programmable data processing device, such that a series of operational steps are performed on the computer or other programmable device to generate computer-implemented processing, and thus the instructions executed on the computer or other programmable data processing device provides steps for implementing the functions specified in one or more flows of the flowcharts and/or one or more blocks of the block diagrams.

In a typical configuration, a computing device includes one or more processors (CPUs), input/output interfaces, network interfaces, and memory.

The memory may include the form of non-persistent memory, random access memory (RAM), and/or non-volatile memory, etc., in a computer readable medium, such as read only memory (ROM) or flash RAM. Memory is an example of the computer readable medium.

The computer readable medium includes permanent and non-persistent, removable and non-removable media, and can achieve the information storage by any method or technology. The information can be computer readable instructions, data structures, modules of programs, or other data. Examples of computer storage medium include, but are not limited to, phase change memory (PRAM), static random access memory (SRAM), dynamic random access memory (DRAM), other types of random access memory (RAM), read-only memory (ROM), electrically erasable programmable read only memory (EEPROM), flash memory or other memory technology, read-only optical disk read-only memory (CD-ROM), digital versatile optical disk (DVD) or other optical storage, magnetic cartridge tape, magnetic tape-magnetic disk storage or other magnetic storage device, or any other non-transportable media, which can be used to store information that can be accessed by a computing device. As defined herein, computer readable media does not include transitory media, such as modulated data signals and carriers.

It should also be illustrated that, the terms “comprise”, “include” or any other variations is intended to cover a non-exclusive inclusion, such that a procedure, method, item, or device including a series of elements not only includes those elements, but also includes other elements not explicitly listed, or includes elements that are inherent to such a procedure, method, item, or device. An element defined by the phrase “comprise(s) a . . . ” does not exclude the presence of additional same elements in the procedure, method, item, or device including the elements without more limitations.

Those skilled in the art should understand that embodiments of the present application can be provided as a method, system, or computer program product. Accordingly, the present invention may take the form of entire hardware embodiments, entire software embodiments, or embodiments with the combination of software and hardware. Moreover, the present application can take the form of a computer program product implemented on one or more computer-usable storage media (including, but not limited to, magnetic disk memory, CD-ROM, optical memory, etc.) in which computer usable program codes are contained.

The present application can be described in general context of computer-executable instructions executed by a computer, such as program modules. Generally, the program modules include routines, programs, objects, components, data structures, or the like that perform particular tasks or realize particular abstract data types. The present application can also be practiced in distributed computing environments in which tasks are performed by remote processing devices that are connected through a communication network. In distributed computing environments, the program modules can be located in both local and remote computer storage media including storage devices.

Each embodiment in the specification is described in a progressive manner, the same or similar parts in each embodiment are for reference to each other, and each embodiment focuses on differences from other embodiments. In particular, for the system embodiment, since it is basically similar to the method embodiment, the description is relatively simple, and the relevant parts can be referred to the description of the method embodiment.

The above description is only embodiments of the present application and is not intended to limit the present application. Various alterations and changes can be made to the present application for those skilled in the art. Any modifications, equivalents, improvements, etc., made within the spirit and principles of the present application should be included within the scope of the claims of the present application.

1. A method for releasing an evaluation information comprising:
receiving a plurality of operation information, wherein each operation information carries an identity of an object to be evaluated;
determining a feature value corresponding to the object to be evaluated according to said each operation information, and determining a category to which the object to be evaluated belongs according to the identity of the object to be evaluated;
determining a comparison value corresponding to the category, and comparing the feature value corresponding to the object to be evaluated with the comparison value; wherein the comparison value is determined according to feature values corresponding to part or all objects in the category;
determining an evaluation information of the object to be evaluated according to the comparison result; and
releasing the evaluation information.

2. The method according to claim 1, wherein the receiving each operation information carrying an identity of an object to be evaluated comprises:
receiving each operation information carrying the identity of the object to be evaluated sent within a current period according to a preset period.

3. The method according to claim 1, wherein the determining a comparison value corresponding to the category comprises:
determining an attribute of the object to be evaluated according to the identity of the object to be evaluated;
determining other objects whose attribute is the same as the attribute of the object to be evaluated among other objects other than the object to be evaluated in the category; and
determining the comparison value corresponding to the category according to feature values corresponding to the determined other objects.

4. The method according to claim 2, wherein the determining a comparison value corresponding to the category comprises:
determining a historical period corresponding to the current period; and
determining the comparison value determined based on the historical period as the comparison value corresponding to the category, wherein the comparison value determined based on the historical period is determined according to a feature value corresponding to each object in the category determined within the historical period.

5. The method according to claim 2, wherein the determining a comparison value corresponding to the category comprises:
determining the feature value corresponding to each object in the category within the current period according to the operation information carrying the identity of each object in the category received within the current period; and
determining the comparison value corresponding to the category according to the feature value corresponding to each object in the category within the current period.

6. The method according to claim 1, wherein determining an evaluation information of the object to be evaluated according to the comparison result comprises:
determining a score corresponding to the comparison result according to a preset rule; and
determining the evaluation information of the object to be evaluated according to the score.

7. The method according to claim 6, wherein determining the evaluation information of the object to be evaluated according to the score comprises:
determining a rating of a user on the object to be evaluated in history; and
determining the evaluation information of the object to be evaluated according to a preset weight corresponding to the rating and the score.

8. A method for releasing an evaluation information comprising:
receiving a plurality of payment information, wherein each payment information carries an identity of a restaurant;
determining a feature value corresponding to the restaurant according to said each payment information, and determining a category to which the restaurant belongs according to the identity of the restaurant;
determining a comparison value corresponding to the category, and comparing the feature value corresponding to the restaurant with the comparison value; wherein the comparison value is determined according to feature values corresponding to part or all restaurants in the category;
determining an evaluation information of the restaurant according to the comparison result; and
releasing the evaluation information of the restaurant.

9. The method according to claim 8, wherein receiving a plurality of payment information comprises:
receiving each payment information carrying the identity of the restaurant sent within a current period according to a preset period.

10. The method according to claim 9, wherein determining a feature value corresponding to the restaurant according to each payment information comprises:
determining a number of collections of the restaurant in the current period according to each of the received payment information carrying the identity of the restaurant sent within the current period.

11. The method according to claim 8, wherein determining a comparison value corresponding to the category comprises:
determining a geographical area where the restaurant locates according to the identity of the restaurant;
determining other restaurants whose geographical area is the same as the geographical area where the restaurant locates among other restaurants other than the restaurant in the category; and
determining the feature values corresponding to the category according to feature values corresponding to the determined other restaurants.

12. The method according to claim 10, wherein determining a comparison value corresponding to the category comprises:
determining a historical period corresponding to the current period; and
determining an average number of collections determined based on the historical period as the comparison value corresponding to the category, wherein the average number of collections based on the historical period is determined according to the number of collections corresponding to each restaurant in the category determined within the historical period.

13. The method according to claim 10, wherein determining a comparison value corresponding to the category comprises:
determining the number of collections corresponding to each restaurant in the category within the current period according to the payment information carrying an identity of each restaurant in the category received within the current period; and
determining an average number of collections corresponding to the category according to the number of collections corresponding to each restaurant in the category within the current period.

14. The method according to claim 8, wherein determining an evaluation information of the restaurant according to the comparison result comprises:
determining a score corresponding to the comparison result according to a preset rule; and
determining, according to the score, popularity value of the restaurant as the evaluation information of the restaurant.

15. The method according to claim 14, wherein determining popularity value of the restaurant according to the score comprises:
determining a rating of a user on the restaurant in history; and
determining a popularity value of the restaurant according to a preset weight corresponding to the rating and the score.

16. An apparatus for releasing an evaluation information comprising:
a receiving module for receiving a plurality of operation information, wherein each operation information carrying an identity of an object to be evaluated;
a determining module for determining a feature value corresponding to the object to be evaluated according to said each operation information, and determining a category to which the object to be evaluated belongs according to the identity of the object to be evaluated;
a comparing module for determining a comparison value corresponding to the category, and comparing the feature value corresponding to the object to be evaluated with the comparison value; wherein the comparison value is determined according to feature values corresponding to part or all objects in the category; and
a releasing module for determining an evaluation information of the object to be evaluated according to the comparison result, and releasing the evaluation information.

17. The apparatus according to claim 16, wherein the receiving module receives each operation information carrying the identity of the object to be evaluated sent within a current period according to a preset period.

18. The apparatus according to claim 16, wherein the determining module determines an attribute of the object to be evaluated according to the identity of the object to be evaluated, determines other objects whose attribute is the same as the attribute of the object to be evaluated among other objects other than the object to be evaluated in the category, and determines the comparison value corresponding to the category according to the determined feature values corresponding to the other objects.

19. The apparatus according to claim 17, wherein the determining module determines a historical period corresponding to the current period, and determines a comparison value determined based on the historical period as the comparison value corresponding to the category, wherein the comparison value determined based on the historical period is determined according to a feature value corresponding to each object in the category determined within the historical period.

20. The apparatus according to claim 17, wherein the determining module determines a feature value corresponding to each object in the category within the current period according to the operation information carrying the identity of each object in the category received within the current period, and determines the comparison value corresponding to the category according to the feature value corresponding to each object in the category within the current period.

21. (canceled)

22. (canceled)

23. (canceled)

24. (canceled)

25. (canceled)

26. (canceled)

27. (canceled)

28. (canceled)

29. (canceled)

30. (canceled)
